(19) United States
(12) Patent Application Publication
(10) Pub. No.: US 2005/0018948 A1
(43) Pub. Date: Jan. 27, 2005

(54) Method of providing a fibre optic circuit

(76) Inventors: Kathleen Bellekens, Winksele-Delle (BE); Jan Watte, Grimbergen (BE)

Correspondence Address: MYERS BIGEL SIBLEY & SAJOVEC, PO BOX 37428, RALEIGH, NC, 27627, US

(21) Appl. No.: 10/499,739

(22) PCT Filed: Dec. 2, 2002
(86) PCT No.: PCT/GB02/05448

(30) Foreign Application Priority Data
Dec. 14, 2001 (GB) 0129906.4

(51) Int. Cl. G02B 6/12; G02B 6/00

(52) U.S. Cl. 385/14; 385/135

(57) ABSTRACT

A method of assembling a fibre optic circuit (12) comprises the steps of:
providing fibre optic components connected to optical fibres (10) having fibre ends, arranging the fibre optic components on a support, routing the fibre ends in accordance with a predetermined circuit configuration, and splicing and/or connecting the fibre ends so as to complete the circuit, wherein a plurality of fibre ends are spliced substantially simultaneously.

The present invention relates to a method of providing a fibre optic circuit. More in particular, the present invention relates to a method of assembling a fibre optic circuit using fibre optic components which are connected or connectable to optical fibres.

Various types of fibre optic circuits are known for various purposes. Fibre optic circuits may contain splitters, filters, attenuators and other components, each of which is normally provided with optical fibres for connecting these components to other components. This connecting is normally carried out by splicing the ends of the fibres protruding from the components. Some fibres may be provided with connectors which facilitate connecting them. However, for permanent connections it is normally preferred to splice the fibres using a suitable splicing device. Such devices are disclosed in, for example, U.S. Pat. No. 4,687,288 and U.S. Pat. No. 5,394,496.

Assembling a fibre optic circuit is laborious and therefore time-consuming. Normally each component of the circuit is individually attached to a support, its fibres are routed and spliced and then the next component is handled. Although this sequential method is very systematic, it is inherently slow and hard to automate.

It is an object of the present invention to eliminate the problems of the Prior Art and to provide a method of assembling a fibre optic circuit which is more economical.

It is another object of the present invention to provide a method of assembling a fibre optic circuit which can be partially or fully automated.

Accordingly, the present invention provides a method of assembling a fibre optic circuit, comprising the steps of:
providing fibre optic components connected to optical fibres having fibre ends,
arranging the fibre optic components on a support,
routing the fibre ends in accordance with a predetermined circuit configuration, and
splicing and/or connecting the fibre ends so as to complete the circuit,
wherein a plurality of fibre ends are spliced or connected substantially simultaneously.

By first arranging the components on a support and then splicing and/or connecting them, a large number of splicing and/or connecting operations can be combined into a single operation, thus making the assembly process more efficient and easier to automate. In particular in the case of splicing as opposed to connecting this is advantageous.

It is possible to splice and/or connect the fibres in batches. In this way, the efficiently is already improved compared to the individual splicing approach of the Prior Art. In a preferred embodiment, however, the step of splicing involves splicing all fibre ends simultaneously.

In preferred embodiments the support is provided with at least one component holder for holding the fibre optic components. This makes it easier to arrange and hold the components in their respective positions. In addition, a fibre holder may be used to (temporarily) hold the fibres while being routed. A splice holder may advantageously be mounted on the support for holding fibre splices.

Preferably, the method of the present invention comprises the additional step of providing a base plate which constitutes the support.

By providing a base plate on which the fibre optic components are mounted and which can then be fitted in an organiser, several advantages are achieved. The first advantage is that it is possible to build a fibre optic circuit (consisting of splices, fibres, connectors and/or other components) which is virtually independent of the dimensions of the organiser or other device in which it is to be fitted. That is, a single “standard” optical circuit may be fitted in a range of organisers. This leads to the second advantage which is that the assembly of the circuit and the mounting on the base plate can be economically automated as the number of (standardised) circuits of the same kind and/or size is significantly increased. The third advantage is that the fibre optic circuits may be pre-fabricated, thus saving assembly time in the field.

The base plate or “carrier” preferably is substantially flat but may have protrusions and/or notches to align and/or mount optical components. The dimensions of the base plate are chosen so as to suit a range of organisers.

Although the base plate carrying the optical components may be installed in an organiser or other device in the field, it is advantageous to mount the base plate in the device during production of the organiser, that is, under factory conditions. This makes the installation of the device in the field even simpler as the device is provided which is pre-fitted with fibre optic circuitry.

As stated above, the fibre optic circuitry will usually include a length of optical fibre, part of which may be slack (or “overlength”) fibre for later splicing and/or rearranging. When assembling a circuit in accordance with the present invention, it is preferred that the method of the present invention includes the step of arranging any slack fibre in loops and folding the loops so as to decrease the surface area of the circuit. Preferably, the loops are folded back onto the base plate. By arranging the slack fibre in loops, a high degree of organisation may be achieved while allowing a simple storing of the slack length in the device.

The present invention further provides a kits-of-parts for forming an optical fibre organiser in accordance with the method defined above, and an optical fibre organiser thus obtained.

The invention will now further be described with reference to exemplary embodiments illustrated in the accompanying drawings in which:

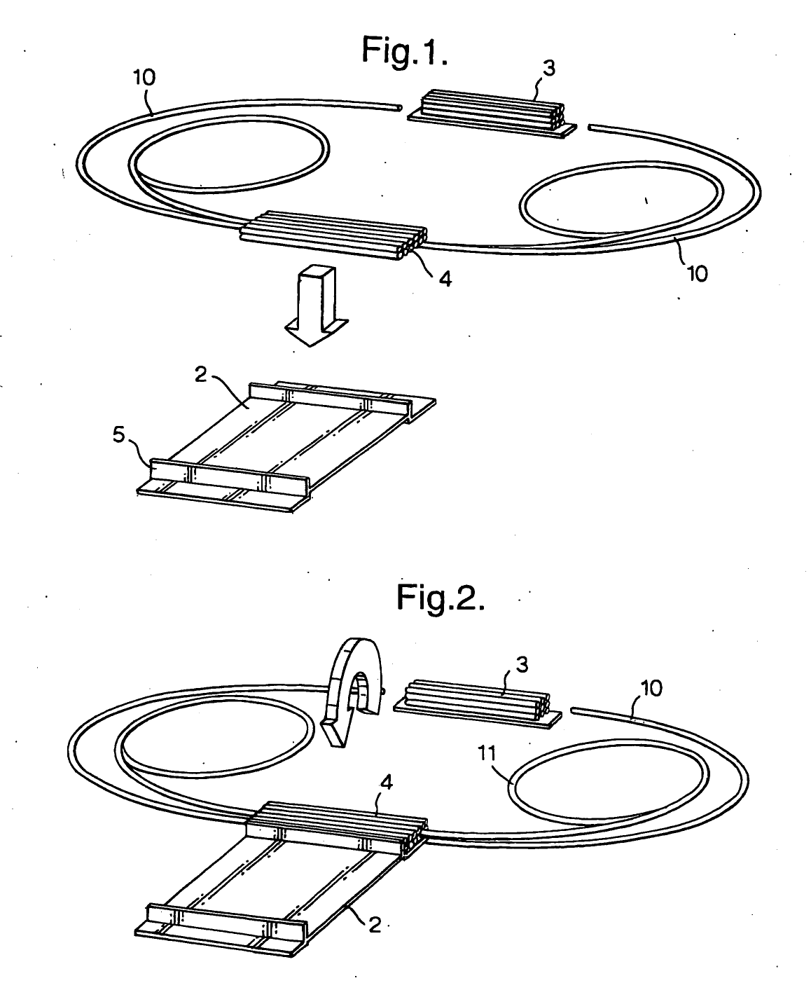

FIG. 1 schematically shows, in perspective, a first step of the method according to the invention;

FIG. 2 schematically shows, in perspective, a second step of the method according to the invention.

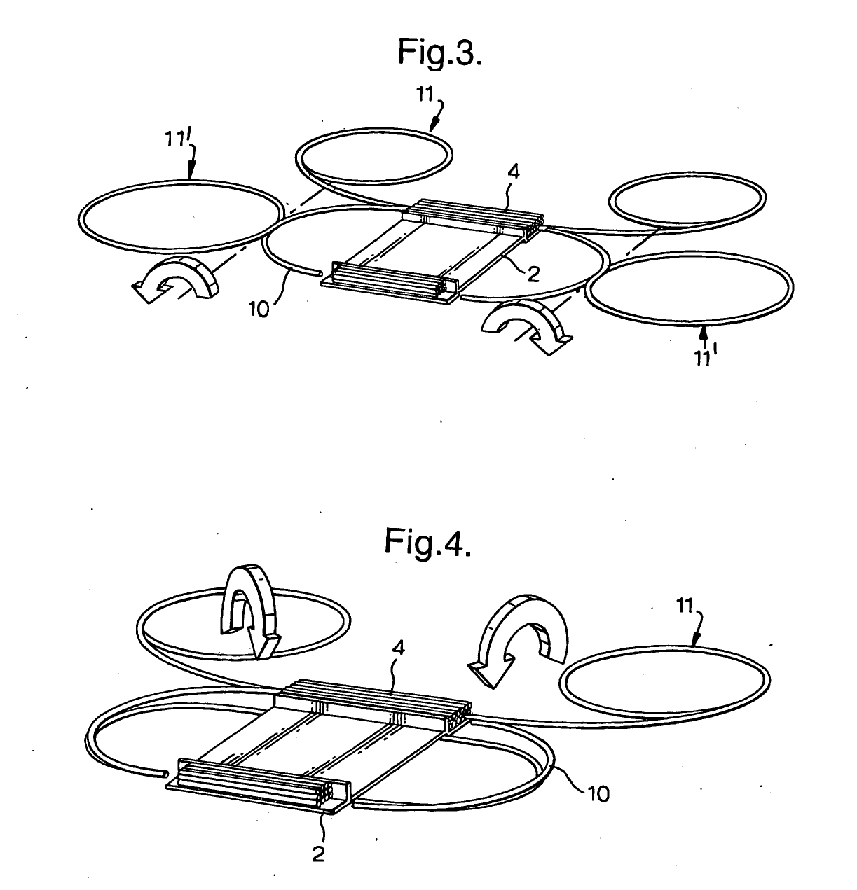

FIG. 3 schematically shows, in perspective, a third step of the method according to the invention.

FIG. 4 schematically shows, in perspective, a fourth step of the method according to the invention.

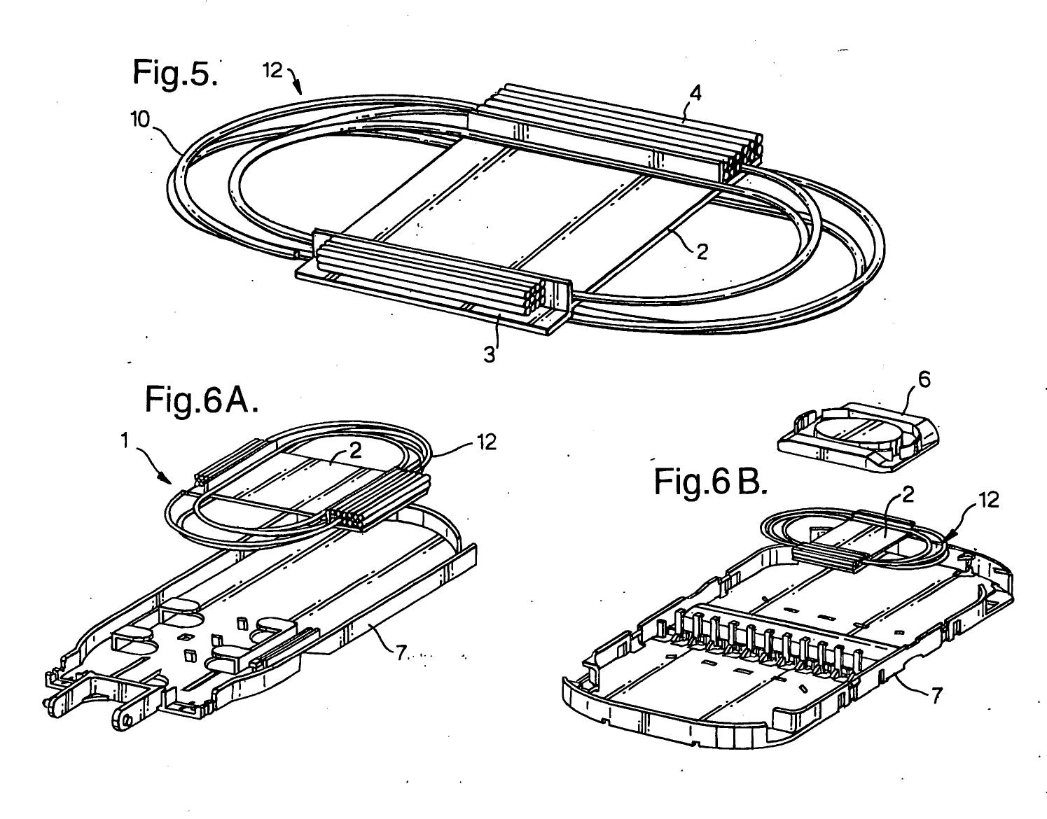

FIG. 5 schematically shows, in perspective, a fifth step of the method according to the invention.

FIGS. 6A and 6B schematically show, in perspective, a sixth step of the method according to the invention.

As shown merely by way of non-limiting example in FIG. 1 a base plate 2 is provided for supporting a fibre optic circuit. The base plate 2 shown has protrusions 5 for positioning optical components and/or suitable component holders such as a first component holder (for example for accommodating an array of splitters) 3 and a second component holder (for example a splice holder) 4. These holders 3, 4 may be fixed to the base plate 2 by gluing (for example using a UV-curable glue) or by snap-fitting.

In accordance with the present invention the optical components of the circuit are first arranged in their respective positions and then spliced collectively. These positions are preferably their final positions but an intermediary arrangement for assembly purposes is possible. To arrange the components, they are advantageously accommodated in one or more component holders 3 in which they can be glued, snap-fitted or mounted in any other manner.

Then the optical fibres 10 protruding from the components are routed, that is, their ends are guided to their counterparts in accordance with the desired circuit configuration. Advantageously, the fibre ends thus routed may be temporarily accommodated in a fibre holder (not shown) which may have a comb-like structure. A number of fibre ends, preferably all fibre ends of the circuit, are thus routed and suitably arranged. Subsequently, the arranged fibres are spliced, advantageously splicing a plurality or even all fibres in one processing step, preferably substantially simultaneously.

For example, the said single processing step may involve cleaving all fibre ends in one operation.

The resulting splices are accommodated, in the example shown, in the second component bolder (splice holder) 4. The length of the optical fibres depends on the specific design of the optical circuit and is preferably predetermined.

As will be clear from the above example, the present invention provides an improved method of assembling a fibre optic circuit. In the method of the present invention the fibres are first routed and then spliced collectively, as opposed to Prior Art methods in which the steps of arranging the component, routing the fibres and splicing the fibre ends were carried out separately for each component. It will be understood that the step of splicing may include a step of cleaving so as to create smooth fibre ends which are suitable for splicing.

In the next stage, shown in FIG. 2, the first component holder 3 is moved over the second component 4, as indicated by the arrow, and is also placed on the base plate 2. A length of fibre 10 is moved with the first component holder 3 while leaving loops 11 of overlength fibre adjacent the base plate 2. Then, as shown in FIG. 3, the lengths of fibre 10 are twisted so as to create further loops 11′, thus organising the fibres 10. These further loops 11′ are folded back, as shown by the arrows, resulting in the arrangement shown in FIG. 4. Folding the loops 11 onto the base plate 2, as indicated by the arrows in FIG. 4, leads to the arrangement of FIG. 5.. The resulting fibre optic circuit 12 may then or at a later stage, be placed in an organiser body, as shown in FIGS. 6A and 6B.

The organiser body (tray) 7 shown in FIG. 6A accommodates the fibre optic circuit 12, thus forming a fibre optic organiser 1. This type of organiser is suitable for use in a dome-shaped closure. The organiser body (tray) 7 of FIG. 6B has different dimensions and a different shape but also accommodates the fibre optic circuit 12. A cover 6 may be provided to cover the fibre optic circuit 12.

As will be clear from the above examples, the present invention also provides a footprint-independent method of assembling fibre optic organisers: a single base plate can be used to provide a fibre optic circuit for organisers or other devices having various dimensions. In addition, the method is substantially circuit-independent as various components may be mounted on a standard base plate. The possibility of pre-fabrication of the optical circuits allows both automation of the circuit assembly and a quick and simple installation in the field.

It will be understood by those skilled in the art that the present invention is not limited to the embodiments shown and that many additions and modifications are possible without departing from the scope of the present invention as defined in the appending claims.

1. A method of assembling a fibre optic circuit, comprising:
providing fibre optic components connected to optical fibres having fibre ends,
arranging the fibre optic components on a support,
routing the fibre ends in accordance with a predetermined circuit configuration, and
splicing and/or connecting the fibre ends so as to complete a circuit based on the predetermined circuit configuration,
wherein a plurality of the fibre ends are spliced or connected substantially simultaneously.

2. A method according to claim 1, wherein splicing and/or connecting the fibre ends comprises splicing all the fibre ends simultaneously.

3. A method according to claim 1, wherein the fibre optic components comprise splitters and/or filters.

4. A method according to claim 1, wherein the support includes a component holder configured to hold the fibre optic components.

5. A method according claim 1 further comprising providing a base plate constitutes as the support.

6. A method according to claim 5, wherein the base plate includes protrusions and/or notches configured to align and/or mount optical components.

7. A method according to claim 1 further comprising arranging any slack optical fibres in loops and folding the loops so as to decrease the surface area of the circuit.

8. A method according to claim 1 further comprising positioning the completed circuit in a fibre optic organiser tray.

9. A kit-of-parts for forming a fibre optic circuit according to the method of claim 1.

10. (Canceled).
